(19) United States
(12) Patent Application Publication
(10) Pub. No.: US 2010/0201091 A1
(43) Pub. Date: Aug. 12, 2010

(54) SINGLE-WHEELED AND DOUBLE-WHEELED WHEELBARROW

(76) Inventor: Monte T. Easterling, Clanton, AL (US)

Correspondence Address: BUSH INTELLECTUAL PROPERTY LAW;c/o CPA Global, P.O. Box 52050, Minneapolis, MN, 55402, US

(21) Appl. No.: 12/702,819

(22) Filed: Feb. 9, 2010

Related U.S. Application Data
(60) Provisional application No. 61/207,213, filed on Feb. 10, 2009.

(51) Int. Cl. B62B 1/20; B25B 27/14

(52) U.S. Cl. 280/47.31; 29/281.5

(57) ABSTRACT

A system and kit to modify a wheelbarrow to a single-wheeled wheelbarrow or a double-wheeled wheelbarrow configuration. The kit has a pair of axles, a pair of wheels, and a sleeve. To form a single-wheeled wheelbarrow, an axle is inserted through a first axle bracket, through a wheel, and then through a second axle bracket. A pin is inserted through a hole at the tip of the axle. To form a double-wheeled wheeled barrow, a first axle is inserted through a first wheel and then through a first axle bracket. A second axle is inserted through a second wheel and then through a second axle bracket. A sleeve holds the ends of both the axles. Pins are utilized for locking the axles with the corresponding axle brackets or sleeve. In the single-wheeled configuration the second wheel, second axle, and sleeve can be stored on the wheelbarrow.

### CROSS-REFERENCE TO RELATED APPLICATION

The present application claims priority to U.S. Provisional Patent Application No. 61/207,213, filed Feb. 10, 2009, the disclosure of which is incorporated herein by reference.

### FIELD OF THE INVENTION

The present invention relates to wheelbarrows and, more specifically, to a method, system, and kit for converting a single-wheeled wheelbarrow into a double-wheeled wheelbarrow or a double-wheeled wheelbarrow into a single-wheeled wheelbarrow.

### BACKGROUND OF THE INVENTION

Wheelbarrows have been used for transportation of all types of materials in many types of locations since ancient times. They facilitate movement of material in difficult terrains, where motorized equipment cannot be used. Although, they have a limited carrying capacity, wheelbarrows can be handy in movement of materials that cannot be ordinarily carried by humans. By distributing the load between the wheel and the human, they allow construction workers to carry a relative large load, thus increasing the operational efficiency of the worker.

Usually, wheelbarrows are designed to have a single wheel; however, double-wheeled wheelbarrows are also very common. These are specifically useful when large materials need to be transported; the two wheels provide additional support by distributing the load between the two wheels resulting in less effort to push the wheelbarrow.

Various designs have been suggested to improve wheelbarrows in order to make them lighter, stronger, and faster. However, the hauling capacity, the terrain, and the type of operation determine the type of wheelbarrow to be used. For example, a single-wheeled wheelbarrow is easy to haul and turn, but falls short when hauling capacity is an issue. Likewise, a double-wheeled wheelbarrow is designed to carry large quantities of material but is clumsy when it comes to turning or moving it in a circle. In addition, due to a large amount of weight, dispensing of hauled material is difficult in a double-wheeled wheelbarrow. Further, it is difficult to shake, while dispensing out the material. In addition, the double-wheeled wheelbarrow may require twice the maintenance compared to a single-wheeled wheelbarrow. Therefore, there exists a need for a wheelbarrow which overcomes the limitation of capacity and load distribution by being configurable as a single-wheeled or a double-wheeled wheelbarrow on as needed basis.

### SUMMARY OF THE INVENTION

The present invention includes a kit for a wheelbarrow comprising a pair of axles, a pair of wheels and tires, and a sleeve to provide a single-wheeled wheelbarrow or a double-wheeled wheelbarrow. A main frame on a wheelbarrow includes two handles and two legs; each handle has a bracket attached a suitable distance from a front end bumper. The handle has an upper and a lower side. An axle bracket is fastened to each of the handles. When a wheelbarrow is to be configured as a single-wheeled wheelbarrow, an axle is inserted into a first axle bracket attached to a first handle. A wheel and tire is then inserted onto the axle. Subsequently, the axle passes through a second axle bracket attached to a second handle and beyond it. A pin/clip is inserted through a hole at the tip of the axle to retain the axle within the axle brackets.

Likewise, when the wheelbarrow is configured as a double-wheeled wheeled barrow, two axles and two wheels/tires are utilized. A first axle is passed through the center of a first wheel and tire and then through the axle bracket attached to the first handle. Similarly, a second axle is inserted through the center of a second wheel and tire and subsequently through the second axle bracket attached to the second handle. A sleeve between the first handle and the second handle holds the ends of both the axles. Pins/clips are utilized for locking the axles with the corresponding axle brackets or sleeve. In the single-wheeled configuration the second axle, sleeve, and second pin/clip can be stored in front of the carrying bin of the wheelbarrow. The second wheel/tire can be stored under the carrying bin.

The present invention provides a system for creating both a one-wheeled or a two-wheeled configuration in a wheel barrow in which the wheelbarrow has a first handle and a second handle, each handle having an inner side, an outer side, and an axle bracket to support an axle. A first wheel and a second wheel, each have a hub to engage an axle. A first axle and a second axle each have a first end and a second opposite end, with the first end constructed not to pass through the axle brackets. Each axle bracket has a hole alignable with a hole in the first axle and in the second axle. A double-wheeled wheel barrow is formed by placing a first wheel next to the outer side of a first handle, inserting the second opposite end of a first axle through the hub of the first wheel, then through the axle bracket of the first handle, then into a first end of an axle sleeve, and inserting a hitch pin through a hole in the axle bracket of the first handle and through a hole in the first axle to secure the first axle to the first handle; inserting the second opposite end of a second axle through the hub of the second wheel, then through the axle bracket of the second handle, then into a second opposite end of an axle sleeve. A hitch pin is then inserted through a hole in the axle bracket of the second handle and through a hole in the second axle to secure the second axle to the second handle, wherein the first wheel and the second wheel are positioned on the outer sides of the first handle and the second handle. A single-wheeled wheelbarrow is formed by inserting the second opposite end of a single axle, selected from the first axle and the second axle, through the axle bracket of the first handle, through the hub of a single wheel, selected from the first wheel and the second wheel, through the axle bracket of the second handle. A hitch pin is then inserted through a hole in the single axle at the second opposite end of the single axle to secure the single axle to the first handle and to the second handle. The single wheel is, thus, positioned between the inner sides of the first handle and the second handle.

The present invention provides a kit for constructing a one-wheeled or a two-wheeled wheel barrow from a standard wheelbarrow. The kit may contain a pair of wheels and at least two axles, each having a hole alignable with holes on axle brackets attached to handles of a wheel barrow. The axles each have a first end and a second opposite end wherein the first end is constructed not to pass through the axle brackets. At least one of the axles has a hole near the second opposite end. The kit may include an axle sleeve for receiving and retaining the second opposite ends of the axles. The kit may further include two hitch pins for insertion through holes in the axle brackets and through holes in the axles to form a two-wheeled wheel barrow, wherein the holes in the axles are alignable with the holes in the axle brackets, or for the insertion of one of the hitch pins through a hole in one of the axles, at the second opposite end of the axle, to form a one-wheeled wheel barrow.

An advantage of the present invention is a method, system, and kit that can rapidly convert a single-wheeled wheelbarrow into a double-wheeled wheel barrow.

Another advantage is the ability to store a second wheel, axle, and pin conveniently on the wheel barrow when the wheelbarrow is in the single-wheeled configuration.

Another advantage is an economical provision of both a single-wheeled wheelbarrow and a double-wheeled wheel barrow.

### BRIEF DESCRIPTION OF THE DRAWINGS

FIG. 1 depicts a perspective view of a single-wheeled wheelbarrow of the present invention.

FIG. 2 depicts a bottom view of the single-wheeled wheelbarrow.

FIG. 3 depicts a side view the single-wheeled wheelbarrow with the second wheel strapped under the wheelbarrow bin.

FIG. 4 depicts a top view of the single-wheeled wheelbarrow with storage of the second axle and sleeve in front of the wheelbarrow bin.

FIG. 5 depicts a perspective view of a double-wheeled wheelbarrow of the present invention.

FIG. 6 depicts a front view of the double-wheeled wheelbarrow.

FIG. 7 depicts a bottom view of the double-wheeled wheelbarrow.

### DETAILED DESCRIPTION OF THE INVENTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

The structural elements described herein include tubular metal structures; the structural elements may be rods or beams molded into square, rectangular, triangular, octagonal, pentagonal, hexagonal or some other geometrical shape without deviating from the scope and spirit of the invention.

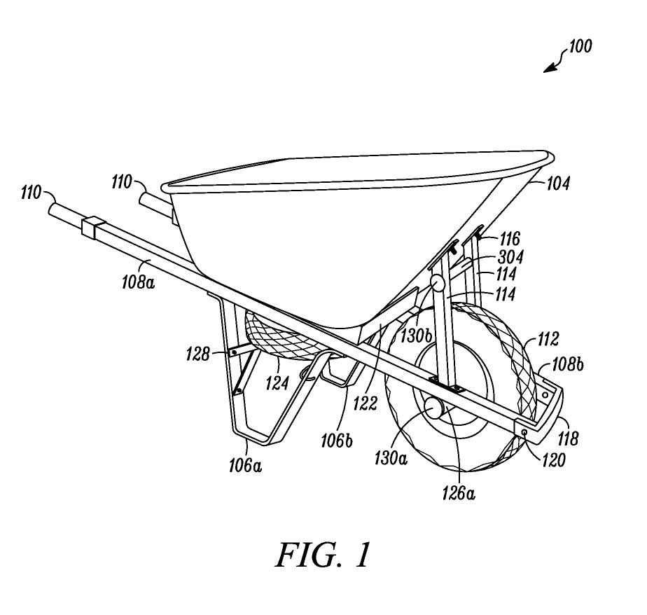

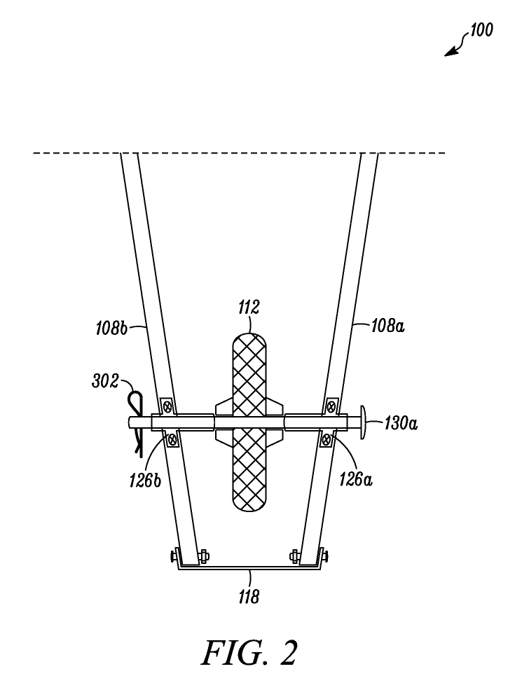

FIG. 1 (side perspective view) and 2 (bottom view) show a wheelbarrow 100 of the present invention. The wheelbarrow 100 includes a main frame coupled to a wheelbarrow bin 104. The main frame includes a plurality of handles 108 such as the handle 108a on one side and a handle 108b on the opposite side of wheelbarrow 100. The main frame includes a pair of legs 106a and 106b. Each of the handles 108a, 108b is fabricated to have handgrips 110 at one end, while at the other end a bumper 118 is attached using nuts and bolts 120. Although, the bumper 118 is attached using nuts and bolts, other means of affixing the bumper 118 to the handles 108a, 108b such as welding and fabrication may be utilized.

Handgrips 110 facilitate its easy movement of wheelbarrow 100 and easy discharge of material without causing any injury to the hands of the operator. The handgrips 110 facilitate lifting or moving the wheelbarrow 100 and overturning wheelbarrow 100 to discharge material from the wheelbarrow bin 104. The handgrips 110 can be of nylon, cloth, rubber and the like and may be affixed by sliding them over the handles 108a, 108b.

Solid metal bars or tubular metal rods/beams may be utilized to form the handles 108a, 108b. The handles 108a, 108b can also be constructed using, plastic, wood, alloy, polymer, and the like. Handles 108a, 108b may include a hollow space inside wherein the space can be utilized to store additional axles and the like. Fixtures can be provided inside a hollow handle for retaining the extra axles. In use, the handgrip 110 may be removed from the handle 108, an axle may be placed inside the handle 108, and the handgrip 110 affixed thereafter.

The handles 108a, 108b have legs 106a, 106b attached thereto. The legs 106 facilitate the placement of the wheelbarrow 100 on the ground. Apart from providing support to the main frame, when stationary, a second wheel and tire 124 may be placed in between the legs 106 and just below the wheelbarrow bin 104. In addition, the legs 106 may be utilized for tilting the wheelbarrow 100 sideways, wherein a leg may then act as fulcrum for easy dispensing of material from the wheelbarrow bin 104.

While one end of the handles 108a, 108b have a handgrips 110, the other opposite ends are attached to the bumper 118, fastened by nuts and bolts 120. At a suitable distance from the bumper 118, a pair of undercarriage brackets or axle brackets 126a and 126b are attached to the handles 108a, 108b for inserting an axle. An axle 130a is inserted axially through axle bracket 126a, then through the center of a first wheel and tire 112. The axle 130a then passes out of the first wheel and tire 112 and through the other axle bracket 126b. Finally, a pin 302 is inserted into a hole in the tip of axle 130a. The pin ensures that the first wheel and tire 112 are kept in position during movement of the wheelbarrow 100. The axle brackets 126a, 126b can be fastened to the handle 108a, 108b with nuts and bolts or via welding. The brackets 126a, 126b ensure that the axle 130a aligns with the first wheel and tire 112. In addition, the brackets 126a, 126b restrict lateral movement of the wheelbarrow 100 during conventional movement. Likewise, the pin 302 keeps the axle retained within the first wheel and tire 112 and the axle brackets 126a and 126b. Bumper 118 acts as a safety mechanism for the wheelbarrow 100 during a crash, ensures that the handles 108a and 108b are a fixed distance apart from each other, and imparts strength to the main frame.

The first wheel and tire 112 may be a single-wheeled unit or the wheel may be separate from tire. The wheel may be built from solid metal with a hole at its center for affixing a ball bearing, and the inner perforation of the ball bearing may provide space for inserting the axle 130a. The tire can be inserted over the wheel for firmly securing it with the wheel thus forming the wheel and tire 112. The tire may be made from rubber, polymer, and plastic or of some other material suitable for making the tire. A ball bearing attached to the wheel may be a double-wheeled ball bearing or of some other type as known in the art without deviating from the scope and spirit of the invention. The axle 130a may be built from a light metal such as aluminum to reduce its weight, reduce friction during transportation of material, and facilitate easy storage of the axle 130a on the wheelbarrow 100.

Two vertical bars 114 are affixed on the handles 108a, 108b, one on one side and the other on an opposite side of wheelbarrow bin 104. As shown in FIG. 1, when the wheelbarrow 100 is used as single-wheeled wheelbarrow, the additional accessories such as the second axle 130b can be placed between the vertical bars 114 for storage. The vertical bars 114 can be affixed to the handles 108a, 108b and to the wheelbarrow bin 104 with nuts and bolts 116. A second axle 130b is stored within the vertical bars 114. An Axle sleeve 304 can also be stored within the vertical bars 114 by placing the axle sleeve 304 over the second axle 130b.

A spacer 122 is affixed between the wheelbarrow bin 104 and the handles 108a, 108b. The spacer 122 facilitates the placement of the second wheel and tire 124, when the wheelbarrow 100 is configured as a single-wheeled wheelbarrow. The spacer 122 may be welded or bolted to the handles 108a, 108b. The second wheel and tire 124 can be strapped to the legs 106a and 106b using a rubber or plastic string or cord during single-wheeled wheel operation. Cross bars 128 can be affixed between the two legs 106a, 106b to impart strength to the main frame 102.

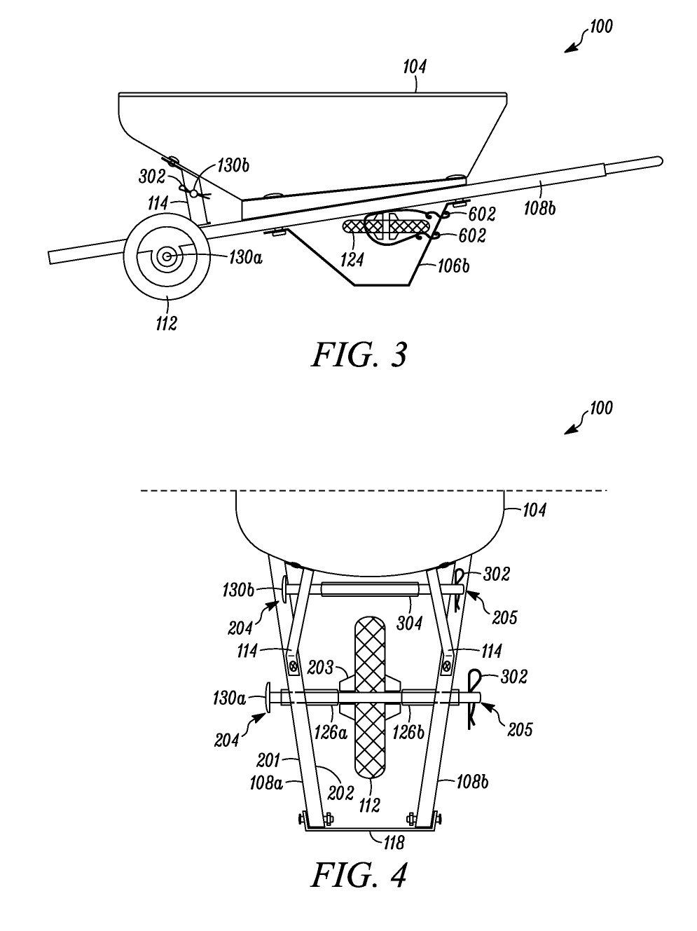

FIG. 3 (side view) and FIG. 4 (top, front view) show further details of wheelbarrow 100. The second wheel and tire 124 is strapped under the wheelbarrow bin 104 using a rubber or plastic strap/cord 602. The second wheel and tire 124 may be affixed using other means such as nuts and bolts, pins, and clips. Handles 108a, 108b have an outer side 201 and an inner side 202. Each wheel and tire 112, 124 have a center or hub 203 to engage axles 130a or 130b. Each axle 130a and 130b has a first end 204 and a second opposite end 205, the first end constructed not to pass through axle brackets 126a, 126b. At least one of axles 130a, 130b have a hole near the second opposite end 205 for the insertion of a hitch pin 302 to retain a single axle within the axle brackets 126a, 126b. The single axle 130a and single wheel 112 form a single-wheeled wheel barrow wherein the single wheel 130a is positioned between the inner sides 202 of the first handle 108a and the second handle 108b.

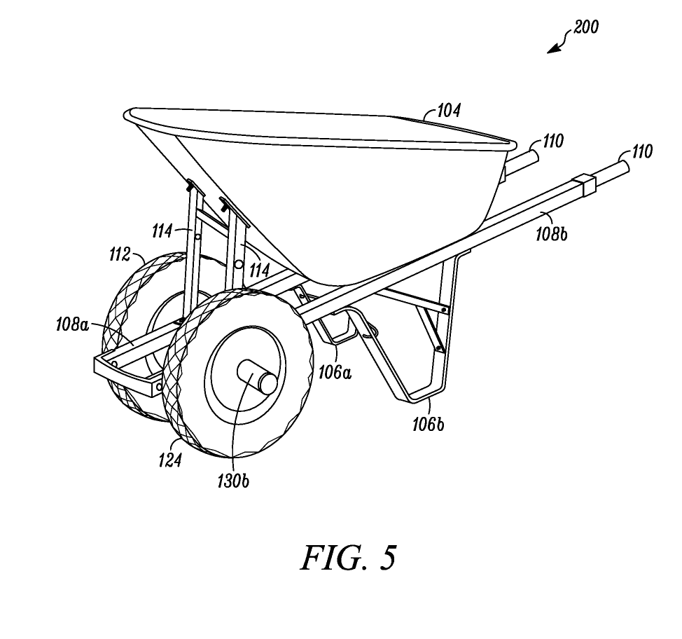

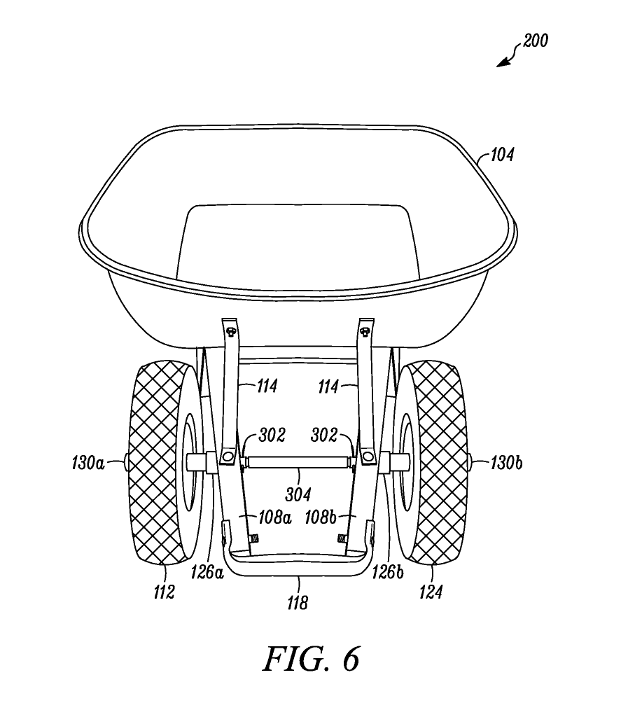

FIG. 5 show a perspective view and FIG. 6 shows a front view of a double-wheeled wheelbarrow 200 of the present invention. In this aspect, the first axle 130a is inserted into the center of the first wheel and tire 112 and then inserted into the axle bracket 126a attached to the handle 108a. Likewise, the second wheel and tire 124 is removed from the bottom of the wheelbarrow bin 104, a second axle 130b is inserted into the center of the second tire and wheel 124 and then through the axle bracket 126b. The axle sleeve 304 fits over the second opposite ends 205 of the axles 130a, 130b. The sleeve 304 ensures that the first axle 130a and the second axle 130b are substantially embedded inside sleeve 304 for smooth movement of the wheels and tires 112, 124.

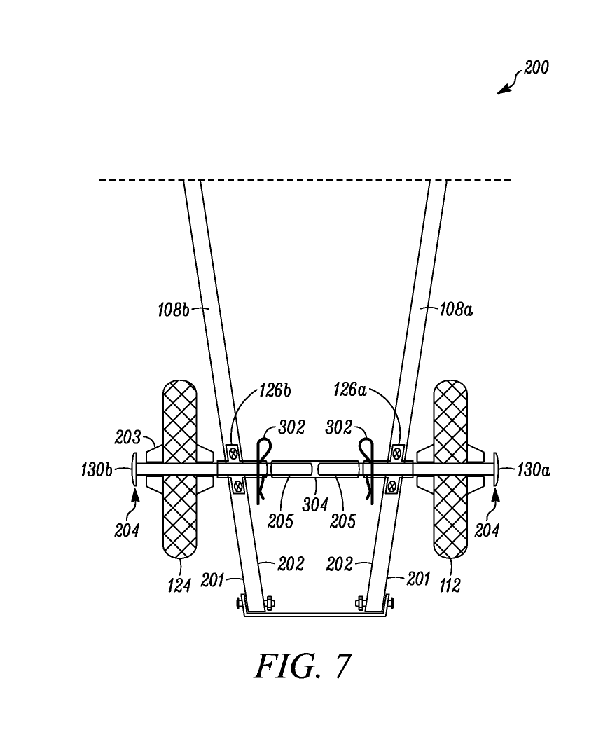

FIG. 7 shows bottom view of the double-wheeled wheelbarrow 200. Pins/clips 302 are inserted through the axle brackets 126a, 126b and through the two axles 130a, 130b to secure axles 130a, 130b to the second handles 108a and 108b, thereby forming the double-wheeled wheelbarrow 200, wherein the first wheel 112 and the second wheel 124 are positioned on the outer sides 201 of handles 108a, 108b.

The axles 130a, 130b may have a flattened head at the first end 204 to hold the wheel in its position and to prevent the first end 204 from passing through a wheel or axle bracket. The flattened first end 204 aligns with the wheel thereby preventing the wheel from moving out or slipping off from the axles. The tire/or wheels 112 and 124 may be identical to each other in all characteristics such as weight, diameter, size of wheel and tire, material, and other features. The opposite second end 205 includes a hole in either or both axles for inserting a pin/clip 302. The pin/clip 302 can be a cotter pin, an R-clip, an R-pin, a linchpin, a bowtie cotter pin, a hitch pin, a circle cotter, or any other suitable type of clip or pin. The pins/clips 302 may also pass through the sleeve 304 and through the axles 130a, 130b to secure the axles to the sleeve 304, rather than to the handles 108a, 108b. The pins/clips 302 also act as a locking mechanism to keep the axles from spinning or sliding out of the axle brackets and the sleeve.

The foregoing description has been limited to specific embodiments of this invention. It will be apparent, however, that variations and modifications may be made by those skilled in the art to the disclosed embodiments of the invention, with the attainment of some of all of its advantages and without departing from the spirit and scope of the present invention. For example, the wheelbarrow bin may be made of metal; however, other material may be used for construction of the wheelbarrow bin including but not limited, to wood, plastic, alloy of different metals, jute, cloth etc. The wheelbarrow bin may be made of special alloy that may resist corrosion. The thickness of the wheelbarrow bin may vary according its use and may be made of metal that is 0.5 to 2.0 mm thick, preferably 1.5 mm thick. The wheelbarrow bin may be varied according to utility and function, and may be perforated to suit the needs of the customers, depending upon a number of parameters including customer requirement, type of material to be transported, utility of the wheelbarrow, and the like. The edges of the wheelbarrow bin may be rounded/folded to avoid injury during handling and to provide strength to the wheelbarrow bin. Further, the carrying capacity of the wheelbarrow bin may be designed as per customer requirement; the carrying capacity may be 50 to 500 liters. The diameters of the first wheel and tire 112 and the second wheel and tire 124 may of any suitable length. The design of the wheels may vary as desired. The handles of the wheelbarrow may be extendible to vary the length of the handles. Various types of clips and elastic cords may be used with the wheelbarrow to secure its load.

It will be understood that various changes in the details, materials, and arrangements of the parts which have been described and illustrated above in order to explain the nature of this invention may be made by those skilled in the art without departing from the principle and scope of the invention as recited in the following claims.

1. A wheelbarrow providing both a one-wheeled or two-wheeled configuration, comprising:
a) first and second handles, each handle having an outer side and an inner side and an axle bracket to support an axle, each axle bracket having holes alignable with holes in an axle;
b) a first wheel and a second wheel, each wheel having a hub to engage an axle;
c) a first axle and a second axle, each axle having a first end and a second opposite end, said first end constructed not passable through the axle brackets;
d) pins insertable through the holes in the axle brackets and through holes in the first axle and the second axle to secure the first axle to the first handle and the second axle to the second handle, thereby forming a double-wheeled wheel barrow wherein the first wheel and the second wheel are positioned on the outer sides of the first handle and the second handle; and
e) at least one of said first axle and said second axle having a hole near said second opposite end for the insertion of a pin to retain a single axle, selected from said first axle and said second axle, within the axle brackets, said single axle having a single wheel, selected from said first wheel and said second wheel, thereby forming a single-wheeled wheel barrow wherein the single wheel is positioned between the inner sides of the first handle and the second handle.

2. The wheelbarrow of claim 1, further comprising an axle sleeve to fit over the second opposite ends of the first axle and the second axle.

3. The wheelbarrow of claim 1, further comprising a wheelbarrow bin wherein one of said first wheel and said second wheel is storable under the wheelbarrow bin.

4. The wheelbarrow of claim 2, further comprising a vertical bar affixed to each of said first and second handles wherein one of said first axle and said second axle and said axle sleeve are storable on the vertical bars.

5. A wheelbarrow providing both a one-wheeled or two-wheeled configuration, comprising:
a) first and second handles, each handle having an outer side and an inner side and an axle bracket to support an axle, each axle bracket having holes alignable with holes in an axle;
b) a first wheel and a second wheel, each wheel having a hub to engage an axle;
c) a first axle and a second axle, each axle having a first end and a second opposite end, said first end not passable through the axle brackets;
d) pins insertable through the holes in the axle brackets and through holes in the first axle and the second axle to secure the first axle to the first handle and the second axle to the second handle, thereby forming a double-wheeled wheel barrow wherein the first wheel and the second wheel are positioned on the outer sides of the first handle and the second handle;
e) at least one of said first axle and said second axle having a hole near said second opposite end for the insertion of a pin to retain a single axle, selected from said first axle and said second axle, within the axle brackets, said single axle having a single wheel, selected from said first wheel and said second wheel, thereby forming a single-wheeled wheel barrow wherein the single wheel is positioned between the inner sides of the first handle and the second handle;
f) an axle sleeve to fit over the second opposite ends of the first axle and the second axle;
g) a wheelbarrow bin wherein one of said first wheel and said second wheel is storable under the wheelbarrow bin; and
h) a vertical bar affixed to each of said first and second handles wherein one of said first axle and said second axle and said axle sleeve are storable on the vertical bars.

6. A wheelbarrow providing both a one-wheeled or two-wheeled configuration, comprising:
a) first and second handles, each handle having an outer side and an inner side and an axle bracket to support an axle, each axle bracket having holes alignable with holes in an axle;
b) a first wheel and a second wheel, each wheel having a hub to engage an axle;
c) a first axle and a second axle, each axle having a first end and a second opposite end, said first end constructed not passable through the axle brackets;
d) an axle sleeve to fit over the second opposite ends of the first axle and the second axle;
e) pins insertable through holes in the axle sleeve and through holes in the first axle and the second axle to secure the first axle and the second axle to the axle sleeve, thereby forming a double-wheeled wheel barrow wherein the first wheel and the second wheel are positioned on the outer sides of the first handle and the second handle; and
f) at least one of said first axle and said second axle having a hole near said second opposite end for the insertion of a pin to retain a single axle, selected from said first axle and said second axle, within the axle brackets, said single axle having a single wheel, selected from said first wheel and said second wheel, thereby forming a single-wheeled wheel barrow wherein the single wheel is positioned between the inner sides of the first handle and the second handle.

7. A system for providing both a one-wheeled or a two-wheeled configuration in a wheelbarrow, wherein the wheelbarrow has a first handle and a second handle, each handle having an inner side, an outer side, and an axle bracket to support an axle, the system, comprising:
a) a first wheel and a second wheel, each wheel having a hub to engage an axle;
b) a first axle and a second axle, each having a first end and a second opposite end, said first end not passable through the axle brackets;
c) each axle bracket having a hole alignable with a hole in the first axle and in the second axle;
d) forming a double-wheeled wheel barrow by placing the first wheel next to the outer side of a first handle, inserting the second opposite end of the first axle through the hub of the first wheel, then through the axle bracket of the first handle, and inserting a hitch pin through the hole in the axle bracket of the first handle and through the hole in the first axle to secure the first axle to the first handle; inserting the second opposite end of the second axle through the hub of the second wheel, then through the axle bracket of the second handle, and inserting a hitch pin through the hole in the axle bracket of the second handle and through the hole in the second axle to secure the second axle to the second handle, wherein the first wheel and the second wheel are positioned on the outer sides of the first handle and the second handle; and
e) forming a single-wheeled wheel barrow by inserting the second opposite end of a single axle, selected from the first axle and the second axle, through the axle bracket of the first handle, through the hub of a single wheel, selected from the first wheel and the second wheel, through the axle bracket of the second handle, and inserting a hitch pin through a hole in the single axle at the second opposite end of the single axle to secure the single axle to the first handle, wherein said single wheel is positioned between the inner sides of the first handle and the second handle.

8. The system of claim 7, further comprising inserting the second opposite end of a first axle into a first end of an axle sleeve, and inserting the second opposite end of the second axle into a second opposite end of the axle sleeve.

9. The system of claim 8, further comprising a wheelbarrow bin wherein one of said first wheel and said second wheel is storable under the wheelbarrow bin.

10. The system of claim 8, further comprising a vertical bar affixed to each of said first and second handles wherein one of said first axle and said second axle and said axle sleeve are storable on the vertical bars.

11. A system for providing both a one-wheeled or a two-wheeled configuration in a wheelbarrow, wherein the wheelbarrow has a first handle and a second handle, each handle having an inner side, an outer side, and an axle bracket to support an axle, the system, comprising:
a) a first wheel and a second wheel, each wheel having a hub to engage an axle;
b) a first axle and a second axle, each having a first end and a second opposite end, said first end not passable through the axle brackets;
c) each axle bracket having a hole alignable with a hole in the first axle and in the second axle;
d) forming a double-wheeled wheel barrow by placing the first wheel next to the outer side of a first handle, inserting the second opposite end of the first axle through the hub of the first wheel, then through the axle bracket of the first handle, then into a first end of an axle sleeve, and inserting a pin through the hole in the axle bracket of the first handle and through the hole in the first axle to secure the first axle to the first handle; inserting the second opposite end of the second axle through the hub of the second wheel, then through the axle bracket of the second handle, then into a second opposite end of the axle sleeve, and inserting a pin through the hole in the axle bracket of the second handle and through the hole in the second axle to secure the second axle to the second handle, wherein the first wheel and the second wheel are positioned on the outer sides of the first handle and the second handle;
e) forming a single-wheeled wheel barrow by inserting the second opposite end of a single axle, selected from the first axle and the second axle, through the axle bracket of the first handle, through the hub of a single wheel, selected from the first wheel and the second wheel, through the axle bracket of the second handle, and inserting a pin through a hole in the single axle at the second opposite end of the single axle to secure the single axle to the first handle, wherein said single wheel is positioned between the inner sides of the first handle and the second handle;
f) said wheelbarrow having a wheelbarrow bin wherein one of said first wheel and said second wheel is storable under the wheelbarrow bin; and
g) said wheelbarrow having a vertical bar affixed to each of said first and second handles wherein one of said first axle and said second axle and said axle sleeve are storable on the vertical bars.

12. A system for providing both a one-wheeled or a two-wheeled configuration in a wheelbarrow, wherein the wheelbarrow has a first handle and a second handle, each handle having an inner side, an outer side, and an axle bracket to support an axle, the system, comprising:
a) a first wheel and a second wheel, each wheel having a hub to engage an axle;
b) a first axle and a second axle, each having a first end and a second opposite end, said first end not passable through the axle brackets;
c) each axle bracket having a hole alignable with a hole in the first axle and in the second axle;
d) forming a double-wheeled wheel barrow by placing the first wheel next to the outer side of a first handle, inserting the second opposite end of the first axle through the hub of the first wheel, then through the axle bracket of the first handle, then into a first end of an axle sleeve, and inserting a pin through a hole in the axle sleeve and through the hole in the first axle to secure the first axle to the axle sleeve; inserting the second opposite end of the second axle through the hub of the second wheel, then through the axle bracket of the second handle, then into a second opposite end of the axle sleeve, and inserting a pin through a hole in the axle sleeve and through the hole in the second axle to secure the second axle to the axle sleeve, wherein the first wheel and the second wheel are positioned on the outer sides of the first handle and the second handle; and
e) forming a single-wheeled wheel barrow by inserting the second opposite end of a single axle, selected from the first axle and the second axle, through the axle bracket of the first handle, through the hub of a single wheel, selected from the first wheel and the second wheel, through the axle bracket of the second handle, and inserting a pin through a hole in the single axle at the second opposite end of the single axle to secure the single axle to the first handle, wherein said single wheel is positioned between the inner sides of the first handle and the second handle.

13. A kit for providing a one-wheeled or a two-wheeled wheelbarrow, comprising:
a) a pair of wheels;
b) two axles, each having a hole for insertion of pins through axle brackets and through the axles to form a two-wheeled wheelbarrow;
c) said axles each having a first end and a second opposite end, said first end constructed not passable through the axle brackets; and
d) at least one of said axles having a hole near the second opposite end for insertion of a pin to form a one-wheeled wheelbarrow.

14. The kit of claim 13 further comprising an axle sleeve for receiving and retaining the second opposite ends of the axles.

15. The kit of claim 14 wherein said axle sleeve has holes for insertion of pins through the holes in the axle sleeve and through the holes in the axles.

16. The kit of claim 13 further comprising axle brackets for attachment to the handles of a wheelbarrow.

17. The kit of claim 13 further comprising pins for insertion into the holes of the axle brackets and axles.

18. A kit for providing a one-wheeled or a two-wheeled wheelbarrow, comprising:
a) a pair of wheels;
b) two axles, each having a hole for insertion of pins through axle brackets and through the axles to form a two-wheeled wheelbarrow;
c) said axles each having a first end and a second opposite end, said first end constructed not passable through the axle brackets;
d) at least one of said axles having a hole near the second opposite end for insertion of a pin to form a one-wheeled wheelbarrow;
e) an axle sleeve for receiving and retaining the second opposite ends of the axles;
f) axle brackets for attachment to the handles of a wheelbarrow; and
g) pins for insertion into the holes of the axle brackets and axles.

19. The kit of claim 18 wherein said axle sleeve has holes for insertion of pins through the holes in the axle sleeve and through holes in the axles.
